(19) United States
(12) Patent Application Publication
(10) Pub. No.: US 2004/0217500 A1
(43) Pub. Date: Nov. 4, 2004

(54) System and process for manufacturing building blocks

(76) Inventor: Robert F. Sinclair, Treasure Island, FL (US)

Correspondence Address: Paul M. Denk, Ste. 170, 763 S. New Ballas Road, St. Louis, MO, 63141, US

(21) Appl. No.: 10/815,533

(22) Filed: Apr. 1, 2004

Related U.S. Application Data
(63) Continuation-in-part of application No. 10/411,511, filed on Apr. 10, 2003.
(60) Provisional application No. 60/371,441, filed on Apr. 11, 2002.

(51) Int. Cl. B29C 31/00; B29C 43/02

(52) U.S. Cl. 264/40.1; 264/319; 425/149; 425/406

(57) ABSTRACT

A building block manufacturing system comprising a compression chamber capable of containing compressible block making material, said material comprised entirely or in part of waste material, preferably selected from the group consisting of fly ash, ground wood, waste vegetation matter, sea shells and sand; and a ram capable of exerting a desired pressure on the contents of said compression chamber; wherein, when said block making material being is placed in the compression chamber, the ram may exert a desired pressure on the material thereby compressing, and assisting in the curing or the material into a desired shape conforming to the interior surfaces of the compression chamber. The present invention also comprises the novel method of using the novel block manufacturing system.

### CROSS REFERENCE TO RELATED APPLICATIONS

This application is a continuation-in-part patent application which claims priority to the non-provisional patent application having Ser. No. 10/411,511, filed on Apr. 10, 2003, which claims priority upon the provisional patent application having Ser. No. 60/371,441 which was filed on Apr. 11, 2002.

### BACKGROUND OF THE INVENTION

The present invention relates to a new machine and method for the manufacture of building blocks, and more particularly to a machine and method that rapidly and repeatedly manufactures building blocks constructed generally of waste material, such as fly ash and ground wood.

There are numerous building blocks that are available in the art for use in the construction primarily of commercial and industrial type of buildings, and even for the construction of residential homes. Typically, most of these blocks are fabricated from concrete, poured into a form or mold, left to cure, removed from the form or mold, and allowed to dry. In some instances the blocks are fired in a kiln or other high-temperature oven to expedite the curing and drying process or to secure certain features on one or more faces of the block. Such blocks can be constructed to a variety of shapes.

In U.S. patent application Ser. No. 10/411,511 to Sinclair et al., said application being incorporated by reference herein,;a building block was disclosed that was composed of a high percentage of waste materials such as fly ash and ground wood. Certain methods of manufacturing the waste material building blocks were also disclosed in Sinclair et al. One of the methods of block manufacture disclosed in Sinclair et al. was a continuous mix and extrusion process that would produce lengths of extruded material having a desired cross-sectional shape. The extruded material could then be cut into blocks of a desired length. This method does not produce individually compressed blocks.

In a second method of block manufacture disclosed in Sinclair et al., the waste material block mixture is fed into a compression chamber by an auger and mixer/blender combination. A hydraulic ram then compresses the material into a block in the compression chamber, and the block is then removed from the compression chamber at a right angle to the alignment of the ram. While this second method and the equipment associated with the method provides certain processing advantages, it has been found that the single-chamber configuration and the right-angle output in the method lead to inconsistencies in the shape and size of the blocks produced by this method. Hence, a method improving on this method and equipment to facilitate such a new method is desirable.

### BRIEF SUMMARY OF THE INVENTION

The present invention comprises a building block manufacturing system comprising a compression chamber capable of containing compressible block making material, said material comprised preferably or in part of waste material selected from the group consisting of fly ash, ground wood, waste vegetation matter, sea shells and sand; and a ram capable of exerting a desired pressure on the contents of said compression chamber; wherein, when said block making material being placed in the compression chamber, the ram may exert a desired pressure on the material thereby compressing, and assisting in the curing or the material into a desired shape conforming to the interior surfaces of the compression chamber. The present invention also comprises the novel method of using the novel block manufacturing system.

In one embodiment of the present invention, the system further comprises a fill chamber attached to the compression chamber and capable of receiving the block making material such that the material may be transferred from the fill chamber into the compression chamber by the ram. The system also has a gate at the end of the compression chamber that is closed to keep the block making material in the compression chamber during compression, but which opens to release the newly formed block from the chamber. Ridges can be located on the inner surfaces of the compression chamber to impart desired impression into the blocks during processing. In this embodiment, the ramming device is preferably hydraulic, while the gate is actuated by pneumatics. An electronic control unit is used to control the operation of the system. Obviously, other than pneumatics or hydraulics could be employed in either instance.

### BRIEF DESCRIPTION OF THE DRAWINGS

The objects of the invention are achieved as set forth in the illustrative embodiments shown in the drawings that form a part of the specification.

FIG. 1 is a side view of one of the embodiments of the present invention with the ram shaft retracted into the ram cylinder;

FIG. 2 is a side view of one of the embodiments of the present invention with the ram shaft extended through the fill chamber;

FIG. 3 is a perspective view of a building block of a type that may be formed by an embodiment of the present invention;

FIG. 4 is a top view of a portion of one embodiment of the present invention, showing portions of the hydraulics in said embodiment;

FIG. 5 is a schematic representation of another embodiment of the present having two fill chambers and an alternating ram compression system;

FIG. 6 is a schematic representation of another embodiment of the present invention having an alternating ram compression system and two fill chambers at each end of the ram;

### DETAILED DESCRIPTION

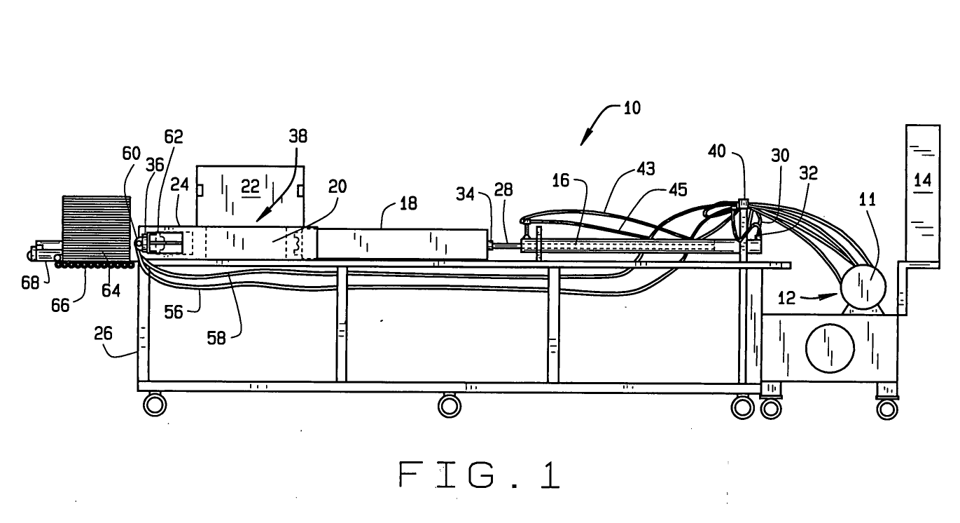

The system for manufacturing building blocks of one embodiment of the present invention is indicated generally at 10 (FIG.1). The system 10 includes a hydraulic pump 11, a motor 12, a control panel 14, a ram cylinder 16, a ram can 18, a fill chamber 20, a fill hopper 22, and a compression chamber 24. The ram cylinder 16, the ram can 18, the fill hopper 22, the fill chamber 20, and the compression chamber 24 are all located on top of a moveable cart or trailer 26, for portability. The ram cylinder 16 has a ram shaft 28 protruding from one end, a hydraulic inlet line 30 and a hydraulic return line 32 along the top of the ram cylinder 16, and an adjustable hydraulic pressure gauge 33 along side the cylinder.

The ram shaft 28 extends to a connector 34 at the rear end of the ram can 18. The ram can 18 has a cross-sectional shape essentially equivalent to that of the shape defined by the interior walls of the fill chamber 20 and compression chamber 24 such that the ram can 18 may be pushed by the ram shaft 28 along the entire length of the fill chamber 20 and compression chamber 24 and through a gate 36 at the far end of the compression chamber 24 to discharge the new block formed by the system 10. There is little clearance between the outer edges of the ram can 18 and the interior surfaces of the chambers 20 and 24.

An opening 38 is located on the top of the fill chamber 20. The opening 38 is surrounded by four vertical walls forming the fill hopper 22 where block making material in input into the system 10.

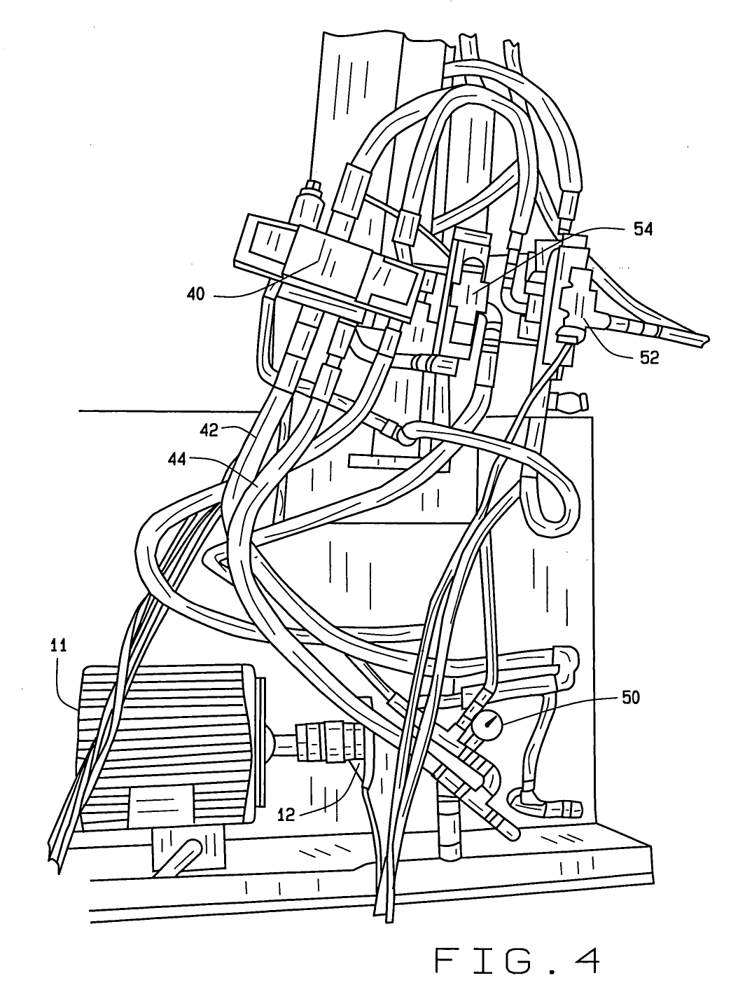

The ram cylinder 16 is activated by hydraulic pressure produced by the motor-driven hydraulic pump 12 that also sits atop a cart or trailer 26. Control panel 14 attached to the cart or trailer 26 supplies power to the motor 11 driving the hydraulic pump 12. A switching module 40 (FIG. 4) regulates the flow of hydraulic pressure between the hydraulic pump 12 and the ram cylinder 16. Hydraulic lines 42 and 44 carry hydraulic fluid from the pump 12 to the switching module 40 and hydraulic lines 46 and 48 carries fluid from the switching module 40 to the ram cylinder 16. A pressure gauge 50 monitors hydraulic pressure in the lines 42 and 44 between the pump 12 and the switching module 40.

The hydraulic lines 43 and 45 allow for transmission of the hydraulic pressure, from its fluid, to pass to the front edge of the ram cylinder 16, where it is desired to return the ram shaft 28 to the back end of the cylinder 16, upon completion of a cycle in the forming of a block within the compression chamber 24. Or, it is just as likely that some type of spring biasing could be used to return the shaft 28, after completion of a cycle. One of the hydraulic lines transmits the pressure under fluid to this location for the cylinder 16, while the other line allows the fluid to be returned, after a cycle. Obviously, all of these various cyclings of the hydraulic fluid, rather under pressure, or for return, are sequenced by the switching module 40, during operations of the system.

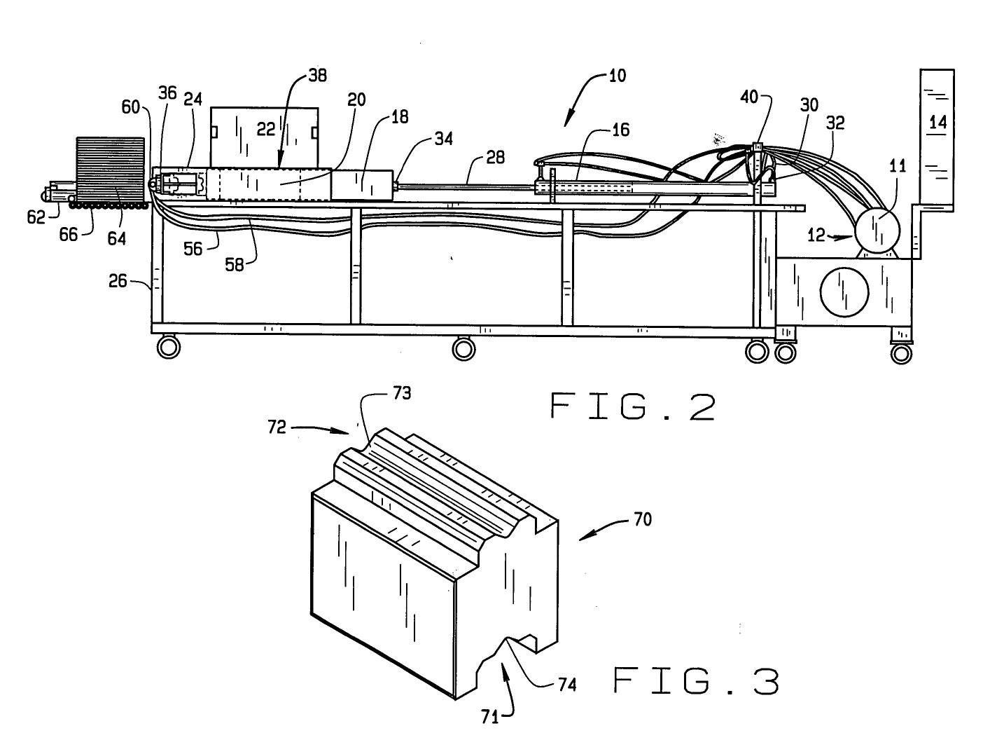

As can be readily seen and understood from the present disclosure, in order to form a building block, the operator of this embodiment of the present invention activates a switch on the control panel 14 (FIG. 1) that starts the machine operation cycle by sending an electric signal to the switching module 40, which in turn opens the hydraulic lines 30 and 32 to the hydraulic cylinder 16. This causes the ram shaft 28 to push the ram can 18 forward, under sufficient pressure, thereby pushing block material from the ram fill chamber 20 forward into the compression chamber 24 where the material is compressed in the compression chamber by the ram can 18 to form a new block. (FIG. 2). These pressures vary in a range of between about 5 to 25 pounds depending upon the material being shaped. The block so produced will have the shape defined by the inner surface of the compression chamber 24 and the face of the ram can 18. (See FIG. 3). The ram can 18 will maintain pressure on the material in the compression chamber 24 for a period of dwell time determined by the operator. As the ram can 18 pushes the block material from the ram fill chamber 20 into the compression chamber 24, the top of the ram can closes the opening 38 in the bottom of the ram fill hopper 22. When the dwell time is satisfied, a timer in the control panel 14 sends an electrical signal to ram switching module 40 neutralizing the module, and at the same time activating switching module 52 to cause the ram can 18 to retract slowly a distance of approximately one inch. This activates a limit switch that sends an electric signal to switching module 54 which sends fluid through hydraulic lines 56 and 58 to a gate cylinder, which in turn opens gate 36 and activates lock cylinders 62.

When the gate 36 is fully open, another limit switch sends an electric signal to activate switching module 40 and thereby cause the ram cylinder 16 to fully extend. The ram cylinder 16 thereby pushes the ram can 8 and a newly formed block forward and out of the compression chamber 24 onto a take off board 64 on a block conveyor 66. When the block is pushed all the way forward and out of the compression chamber 24, the block activates a limit switch that causes the block conveyor 66 to move the new block inches forward. This movement of the new block activates vibrators 68 attached to the fill hopper 22 and activates switch module 40 to fully retract ram can 18.

As ram can 18 retracts beneath fill hopper 22, the opening 38 in the hopper 22 opens to allow new block formulated material to fall, with the assistance of gravity, into the fill chamber 20. (FIG. 1). While so retracting, the ram can 18 triggers a limit switch that activates switching module 54 to activate lines 56 and 58 causing gate cylinder 60 to close compression chamber gate 36. Attached to the gate 36 is a protruding platform that carries the bottom take off board 64 forward with the gate and drags the board to the front edge of the take off conveyor 66. In this way, the board 64 is placed immediately in front of the closed compression chamber gate 36 awaiting the next block to be discharged. When the board 64 is in place, it activates a limit switch that causes lock cylinders 62 to protrude through the sidewalls of the take off conveyor 66 to lock the take off board 64 in place. When the ram can 18 is fully retracted, a limit switch is triggered which activates a variable timer in the control panel 14 to hold this position allowing time for the new block material to drop from the fill hopper 22 to fall and fill chamber 20. When the timer releases, the sequence starts again.

As can be readily understood, the application of the novel block making machine of the present invention is not limited to the exact configuration of the disclosed embodiment. Rather, other embodiments of the present invention are considered. For example, FIG. 5 discloses another embodiment of the present invention in which the ram cylinder 16 has two ram shafts 28A and 28B, where shaft 28A extends from one end of the cylinder and shaft 28B extends from the opposite end of the cylinder. Shaft 28A is attached to a ram can 18A that is slidably movable within a fill chamber 20A through to a compression chamber (not shown). At the other end of the ram cylinder 16, shaft 28B is attached to a ram can 18B that is slidably movable within a fill chamber 20B through to a compression chamber (not shown). Each fill chamber 20A, 20B has its own fill hopper 22A, 22B, respectively. The ram cans 18A, 18B operate according to the disclosed invention, but in a reciprocating manner. That is, after block making material has filled the fill chamber 20A from the fill hopper 22A, the ram cylinder 16 is activated to push the ram can 18A through the fill chamber 20A away from the ram cylinder and toward the compression chamber (not shown) associated with the fill chamber 20A. This action causes the ram shaft 28B to retract from its extended position and pull the ram can 18B toward the ram cylinder 16 to open the fill chamber 20B for re-filling with block making material from the fill hopper 22B. Once block making material has filled the fill chamber 20B from the fill hopper 22B, the ram cylinder 16 can be activated to push the ram can 18B through the fill chamber 20B away from the ram cylinder and toward the compression chamber (not shown) associated with the fill chamber 20B. This action causes the ram shaft 28A to retract from its extended position and pull the ram can 18A toward the ram cylinder 16 to open the fill chamber 20A for re-filling with block making material from the fill hopper 22A. This process then can repeat itself.

Obviously, various hydraulic lines, similar to those as shown in FIGS. 1 and 2, and which are rendered operative through the usage of a related type of switching module, regulated from the control panel, will be used to regulate the pressured shifting of the various ram shafts within and through the ram cylinder 16, as can be readily understood.

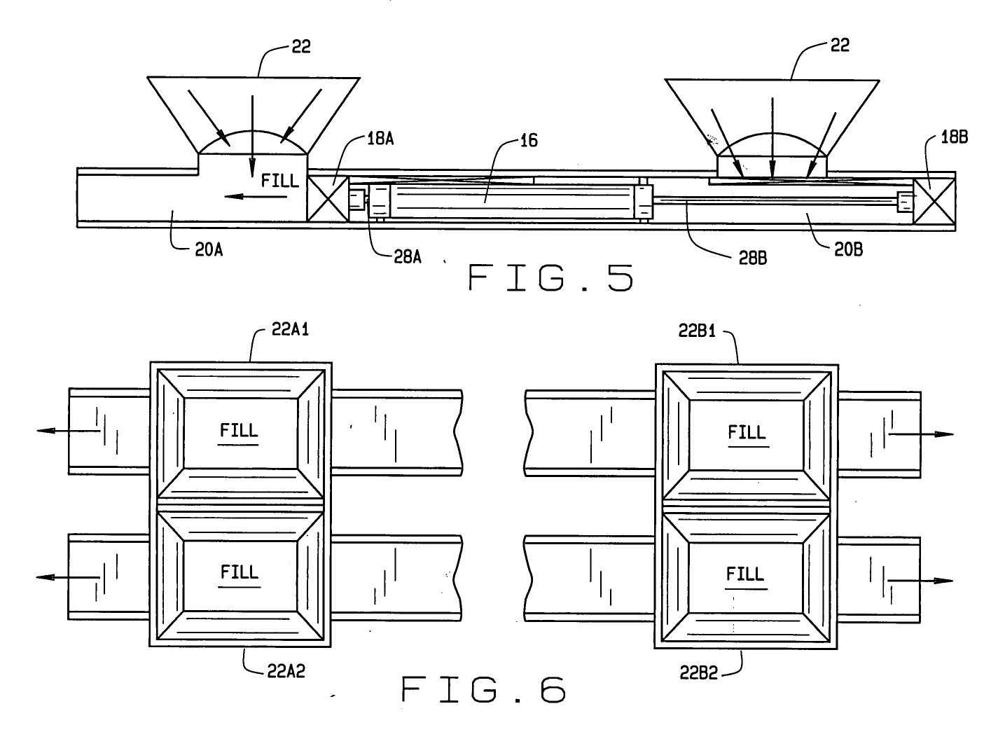

In yet another embodiment of the present invention, the embodiment encompassing a reciprocating ram cylinder may be expanded such that two or more fill hoppers 22A1, 22A2 and 22B1, 22B2 may be located on each side of the reciprocating cylinder 16. (FIG. 6).

In addition, there may be multiple fill chambers 10 or compression chambers 24. The ram 16 may be activated by numerous devices, such as mechanical operation, electrical operation or by pneumatic pressure. Likewise, the gate 36 may be operated by numerous devices, such as by mechanical operation, electrical operation, by hydraulic pressure, or manually operated. The gate 36 may be located on different sides of the compression chamber 24, and an exit gate may be added. Further, the present invention will also operate without a gate 36, since the newly formed blocks may be removed from the compression chamber 24 in a constant flow process, or a similar opening may be located in the fill chamber 20.

Moreover, the switching modules 40, 52, 54 may be comprised of a single switching component, or a grouping of two or more independent switches. The system 10 is not limited to a specific size or shape. The ram can 18 may be formed of a variety of shapes and sizes, as well as the inner shape of the fill chamber 20 and the compression chamber 24, so long as the ram can 18 is capable of forcing the block making material through the chambers. For example, the cross-section of the fill chamber 20 may be square, oval, or some other shape. If the cross-section of the fill chamber 20 is square, the plunger would need to likewise be essentially square, but with a perimeter slightly smaller than the perimeter of the inner surface of the chamber.

The actual cross section of the various fill chambers, in addition to the compression chambers, are what dictate the shape that is given to the formed block. For example, FIG. 3 shows such a block 70, and which may be formed having the shown longitudinal groove 71, along a bottom wall, while the projecting rib 72 are formed along the top wall. Thus, these types of shaped grooves and ribs are complimentary of each other, and can be matingly fitted together, when assembled into a building wall. Any type of mortar or other material may, or even may not, be used, to cement the blocks together, or they may simply interfit together, can be held in that position by means of the complimentary grooves and the ribs. In addition, the block is formed within the compression chamber, obviously, it may be desirable that such grooves and ribs are formed laterally along the sides of the chambers, so as not in interfere with the deposit of the material from the fill hopper 22, as the blocks are being formed and compressed into their final configuration. Then, as stated, the ram can, and perhaps part of the fill chamber, in addition to the compression chamber, will have a similar cross section, so as to form the shape of the block as it is being compressed, within said compression chamber. In addition, as can be noted, the groove and rib formed in the block may contain shallow cavities, as at 73 and 74, so that utility lines, reinforcing bars, electrical conduits, for other type of accessories that may be necessary for completing the construction of the building, in which the blocks of this invention are formed into a wall, can be located, for the convenience of the contractor.

No cart 26 is required to operate the present invention, and no control panel 14 is required since the actuation switches in the switching module may be activated locally. In addition, other configurations incorporating the novel block making machine and method may be readily discerned by one of ordinary skill in the art.

Variations or modifications to the subject matter of this invention may occur to those skilled in the art upon the review of the disclosure as provided herein. Such variations, if within the spirit of this invention, are intended to be encompassed within the scope of any claims to patent protection that are obtained herein. The description of the preferred embodiment, and the analysis of the invention as shown in the drawings, are set forth for illustrative purposes only.

Having thus described the invention, what is claimed and desired to be secured by Letters Patent is:

1. A building block manufacturing machine comprising:
a. a compression chamber capable of containing compressible block making material, said material comprised entirely or in part of waste material selected from the group consisting of fly ash, ground wood, waste vegetation matter, sea shells and sand; and
b. a ram capable of exerting a desired pressure on the contents of said compression chamber;
wherein, when said block making material is placed in the compression chamber, the ram may exert a desired pressure on the material, thereby compressing the material into a desired shape conforming to the interior surfaces of the compression chamber.

2. The building block manufacturing machine of claim 1, further comprising a second compression chamber capable of compressing block making material, and said ram also being capable of exerting a desired pressure on the contents of said second compression chamber, wherein as the ram exerts pressure on the first compression chamber, the second compression chamber may be loaded with block making material, and when the ram exerts pressure on the second compression chamber, the first compression chamber may be loaded with block making material

3. The building block manufacturing machine of claim 1, further comprising a fill chamber, said fill chamber being in proximity to said compression chamber and capable of receiving the block making material, such that the material may be transferred from the fill chamber into the compression chamber by the ram.

4. The building block manufacturing machine of claim 3, wherein the fill chamber is attached to the compression chamber.

5. The building block manufacturing machine of claim 4, wherein the ram, the fill chamber and the compression chamber are all linearly aligned to one another.

6. The building block manufacturing machine of claim 1, wherein the pressure exerted by the ramming device is sufficient to cure said block making material.

7. The building block manufacturing machine of claim 1, further comprising a gate associated with the compression chamber, said gate being capable of closing to retain the contents of the compression chamber in the compression chamber and capable of opening to release the contents of the compression chamber.

8. The building block manufacturing machine of claim 7, further comprising an actuator, said actuator capable of opening said gate.

9. The building block manufacturing machine of claim 7, further comprising an actuator, said actuator capable of closing said gate.

10. The building block manufacturing machine of claim 1, further comprising a ridge on the inner surfaces of said compression chamber, the ridge capable of imparting an impression into the block making material placed in the compression chamber.

11. The building block manufacturing machine of claim 1, wherein the ramming device is hydraulic.

12. The building block manufacturing machine of claim 1, wherein the ramming device is pneumatic.

13. The building block manufacturing machine of claim 1, further comprising an electronic control unit, said control unit capable of controlling one or more of the control functions of the machine.

14. A method for manufacturing building blocks comprising the steps of:
a. Forming a mixture of compressible block making material, said material comprised entirely or in part of waste material selected from the group consisting of fly ash, ground wood, waste vegetation matter, sea shells and sand;
b. Placing said block making material into a compression chamber, the interior surfaces of said chamber having a desired shape; and
c. Compressing said material into a desired shape in said compression chamber with a ram.

15. The method of claim 14, wherein the ram applies sufficient pressure to the compressible block making material in the compression chamber to cure said material.

16. The method of claim 14, further comprising the step of placing said compressible block making material into a fill chamber, the ram forcing the material from the fill chamber into the compression chamber.

17. The method of claim 16, further comprising the step of closing a gate attached to the compression chamber to retain the compressible block making material in the compression chamber.

18. The method of claim 17, further comprising the step of opening the gate to enable the removal of the building block from the compression chamber.

19. The method of claim 18, further comprising the step of using an electronic control unit to monitor and control the operation of the ram and the gate.

20. The building block manufacturing machine of claim 1 wherein a quantity of cement is added to the material selected to form the compressible block.
